(19) United States
(12) Patent Application Publication
(10) Pub. No.: US 2022/0300959 A1
(43) Pub. Date: Sep. 22, 2022

(54) SYSTEM AND METHOD FOR PAYMENT DEVICE ISSUANCE, LIFECYCLE MANAGEMENT, AND USE

(71) Applicant: JPMORGAN CHASE BANK, N.A., New York, NY (US)

(72) Inventors: Mohamed NOAH, London (GB); Abdullah JAVED, New York, NY (US); Dan Cohen SMITH, London (GB); Timothy CHEUNG, London (GB); Wanpeng LIU, London (GB)

(21) Appl. No.: 17/655,421

(22) Filed: Mar. 18, 2022

Related U.S. Application Data
(60) Provisional application No. 63/162,967, filed on Mar. 18, 2021.

(51) Int. Cl. G06Q 20/38; G06Q 20/42; G06Q 20/24

(52) U.S. Cl. CPC G06Q 20/3821; G06Q 20/425; G06Q 20/38215; G06Q 20/3829; G06Q 20/24

(57) ABSTRACT

A method for payment device issuance, lifecycle management, and use may include a financial institution computer program: issuing a numberless, physical first financial instrument that is restricted to in-person transactions having a first primary account number (PAN) stored in a chip to a customer; issuing a digital, second financial instrument to an electronic wallet for the customer having a second PAN that is different from the first PAN; receiving a notification that the first financial instrument or the second financial instrument has been lost or compromised; in response to the first financial instrument being lost/compromised, reissuing the first financial instrument with a third PAN, wherein the second PAN for the second financial instrument is unchanged; and in response to the second financial instrument being lost/compromised, reissuing the second financial instrument with a fourth PAN, wherein the first PAN for the first financial instrument is unchanged.

### FIELD OF THE INVENTION

This application claims priority to U.S. Patent Application Ser. No. 63/162,967 filed Mar. 18, 2021, the disclosure of which is hereby incorporated, by reference, in its entirety.

### BACKGROUND OF THE INVENTION

### 1. Field of the Invention

Embodiments generally relate to systems and methods for payment device issuance, lifecycle management, and use.

### 2. Description of the Related Art

Credit cards, including physical cards and digital cards, offer incredible conveniences to customers when conducting in-person and online (e.g., e-commerce) transactions. A customer need only present the credit card to a point-of-sale device, or enter the primary account number, or “PAN,” during the checkout process. The convenience offered by credit cards also opens them up to fraud, as a fraudster need only get the PAN and maybe the ZIP code of record in order to attempt fraudulent transactions.

### SUMMARY OF THE INVENTION

Systems and methods for payment device issuance, lifecycle management, and use are disclosed. In one embodiment, a method for payment device issuance, lifecycle management, and use may include: (1) issuing, by a financial institution computer program for a financial institution, a first financial instrument to a customer, wherein the first financial instrument is a numberless physical financial instrument having a first primary account number, the first primary account number stored in a chip on the first financial instrument, wherein the first financial instrument is restricted to in-person transactions; (2) issuing, by the financial institution computer program, a second financial instrument to an electronic wallet for the customer as a digital financial instrument, wherein the second financial instrument has a second primary account number that is different from the first primary account number; (3) receiving, by the financial institution computer program, a notification that the first financial instrument or the second financial instrument has been lost or compromised; (4) in response to the first financial instrument being lost or compromised, reissuing, by the financial institution computer program, the first financial instrument with a third primary account number, wherein the second primary account number for the second financial instrument is unchanged; and (5) in response to the second financial instrument being lost or compromised, reissuing, by the financial institution computer program, the second financial instrument with a fourth primary account number, wherein the first primary account number for the first financial instrument is unchanged.

In one embodiment, the method may also include: receiving, by the financial institution computer program, a personal identification number for the first financial instrument or the second financial instrument; assigning, by the financial institution computer program, the personal identification number to both the first financial instrument and the second financial instrument; receiving, by the financial institution computer program, a changed personal identification number for one of the first financial instrument and the second financial instrument; and assigning, by the financial institution computer program, the changed personal identification number to both the first financial instrument and the second financial instrument.

In one embodiment, the first financial instrument and the second financial instrument may be associated with a logical financial instrument identifier.

According to another embodiment, a method for payment device issuance, lifecycle management, and use may include: (1) issuing, by a financial institution computer program for a financial institution, a logical financial instrument identifier to a customer, wherein the logical financial instrument identifier is associated with a plurality of payment devices issued to the customer; (2) receiving, by the financial institution computer program, a request to create a plurality of accounts from a customer mobile electronic device, wherein the plurality of accounts comprise one of a demand deposit account and a savings account; (3) creating, by the financial institution computer program, the plurality of accounts; (4) receiving, by the financial institution computer program, customer preferences for pointing transactions conducted with one of the payment devices associated with the logical financial instrument identifier to one or more of the plurality of accounts; (5) receiving, by the financial institution computer program, a transaction involving one of the payment devices associated with the logical financial instrument identifier; (6) identifying, by the financial institution computer program, one or more of the plurality of accounts for the transaction based on the customer preferences; and (7) settling, by the financial institution computer program, the transaction using the identified one or more accounts.

In one embodiment, the plurality of payment devices may include a physical payment device, a virtual payment device, and/or a payment token.

In one embodiment, the plurality of accounts may also include a line of credit.

In one embodiment, the method may also include: receiving, by the financial institution computer program, a request to close one of the plurality of accounts from the customer mobile electronic device; and closing, by the financial institution computer program, the requested account.

In one embodiment, the customer preferences may be based on a merchant type, a transaction value, a transaction geography, reward point earning, combinations thereof, etc.

In one embodiment, the plurality of accounts for the transaction may be identified after the transaction is complete.

According to another embodiment, a method for payment device issuance, lifecycle management, and use may include: (1) receiving, by a third-party issuer processor computer program and from financial institution computer program for a financial institution, a request to generate a primary account number for a customer, a unique reference identifier for the customer, and a public key for the customer, wherein the financial institution outsources issuance of primary account numbers and lifecycle management of the primary account numbers to the third-party issuer processor; (2) generating, by the third-party issuer processor computer program, the primary account number; (3) associating, by the third-party issuer processor computer program, the primary account number with the unique reference identifier; (4) encrypting, by the third-party issuer processor computer program, the primary account number with the public key for the customer; and (5) sending, by the third-party issuer processor computer program, the encrypted primary account number to an electronic device associated with the customer, wherein the encrypted primary account number is decrypted using a private key for the customer and is stored in an electronic wallet on the electronic device. The financial institution complies with standards for the Payment Card Industry.

In one embodiment, the method may further include: receiving, by the third-party issuer processor computer program, a selection of a personal identification number from the customer, wherein the personal identification number is encrypted with a public key for the third-party issuer processor; decrypting, by the third-party issuer processor computer program, the encrypted personal identification entry with a private key for the third-party issuer processor; and associating, by the third-party issuer processor computer program, the personal identification entry with the primary account number.

In one embodiment, the third-party issuer processor computer program and the financial institution computer program may communicate regarding the primary account number using the unique reference identifier.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for payment device issuance, lifecycle management, and use according to an embodiment;

FIG. 2 depicts a method for payment device issuance, lifecycle management, and use according to one embodiment;

FIG. 3 depicts a method for payment device issuance, lifecycle management, and use according to another embodiment;

FIG. 4 depicts an exemplary card model according to another embodiment;

FIG. 5 depicts a system for payment device issuance, lifecycle management, and use according to another embodiment; and

FIG. 6 depicts a method for payment device issuance, lifecycle management, and use according to another embodiment.

### DETAILED DESCRIPTION OF PREFERRED EMBODIMENTS

Systems and methods for payment device issuance, lifecycle management, and use are disclosed.

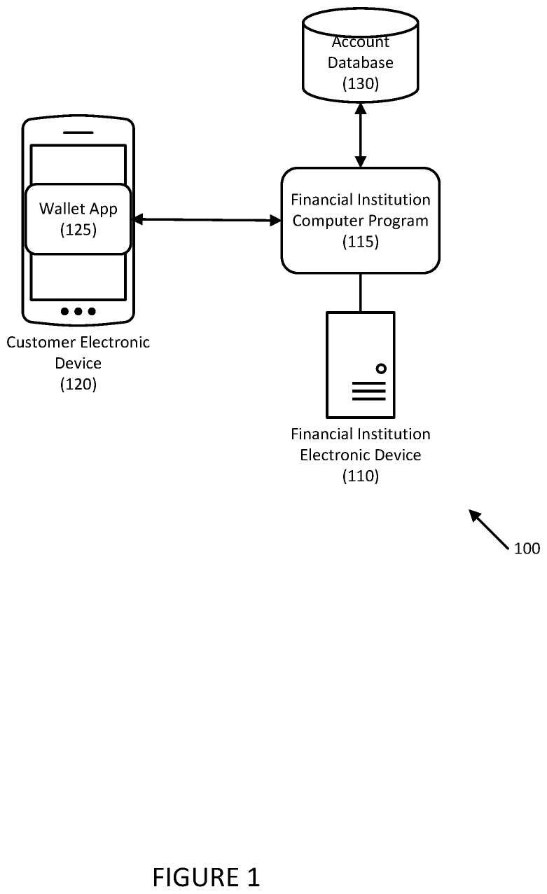

Referring to FIG. 1, a system for payment device issuance, lifecycle management, and use is disclosed according to an embodiment. System 100 may include financial institution electronic device 110 that may execute financial institution computer program 115. Financial institution electronic device 110 may be any suitable electronic device, including servers (e.g., cloud-based and/or physical), workstations, etc. Financial institution computer program 115 may be a computer program that interfaces with an application executed on customer electronic device 120, such as electronic wallet application 125, or “wallet app.” Financial institution computer program 115 may also interface with account database 130, which may maintain primary account numbers (PANs), personal identification numbers (PINs), and other related information for financial instruments that are issued to customers, such as credit cards, debit cards, tokens, etc.

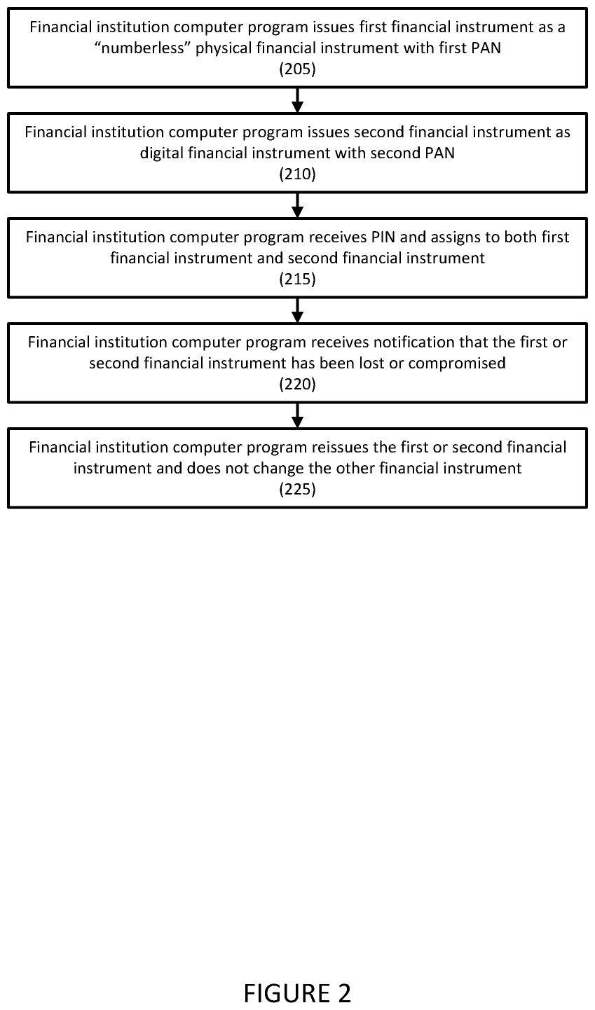

Referring to FIG. 2, a method for payment device issuance, lifecycle management, and use is disclosed according to an embodiment.

In step 205, a financial institution computer program for a financial institution, such as an issuer of financial instruments (e.g., credit cards, debit cards, tokens, etc.) may issue a first financial instrument to a customer (e.g., a cardholder) as a “numberless” physical financial instrument that has a first PAN. The first financial instrument may be a physical device, such as a plastic credit card. The first financial instrument is numberless, in that the first PAN is not printed, embossed, or otherwise visible on the first financial instrument. The PAN may be present, however, in a Europay, Mastercard, and Visa (EMV) chip provided on or in the first financial instrument.

In one embodiment, the first financial instrument may be restricted to in-person transactions and may not be used for e-commerce transactions.

In step 210, the financial institution computer program may issue a second financial instrument to the customer as a digital financial instrument (e.g., a token) that has a second PAN that is different from the first PAN. The second financial instrument may be received in an electronic wallet on the customer's electronic device.

In step 215, the financial institution computer program may receive a PIN for one of the first and second financial instruments, and may assign the PIN to both first financial instrument and second financial instrument. In one embodiment, the PIN may be assigned by the financial institution, may be selected by the customer, etc. The financial institution computer program may keep the PINs synchronized for both the first financial instrument and the second financial instrument, so that any changes to the PINs apply to both financial instruments.

In step 220, the financial institution computer program may receive notification that the first or the second financial instrument has been lost or compromised. For example, the financial institution computer program may receive a notification from the electronic wallet app, from a phone call to a customer service representative, etc.

In step 225, the financial institution computer program may reissue the first or the second financial instrument to the customer. In one embodiment, the financial institution computer program may provide the customer with a new physical device for the first financial instrument with a new PAN if that was the financial instrument that was lost or compromised, or the financial institution computer program may issue a new token with a new PAN for the second financial instrument if that was the financial instrument that was lost or compromised. The PAN for the financial instrument that was not lost or compromised will be unchanged.

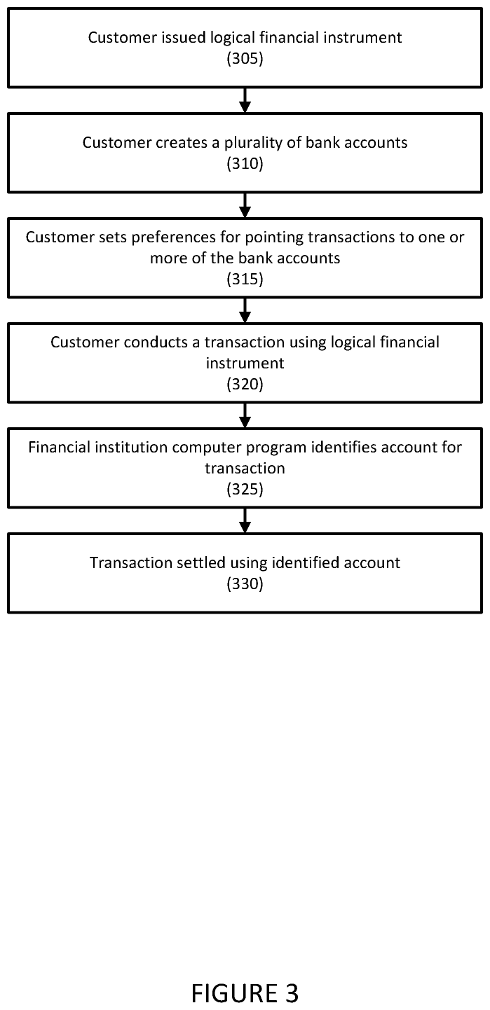

Referring to FIG. 3, a financial institution computer program method for payment device issuance, lifecycle management, and use is disclosed according to another embodiment.

In step 305, a financial institution computer program for a financial institution may issue a customer a logical financial instrument. A logical financial instrument, as used here, may include all financial instruments issued to a customer, including physical cards (including numberless cards), virtual cards, tokens (e.g., ApplePay, GooglePay, MasterCard Digital Enablement Services (MDES) tokens, etc. In one embodiment, each financial instrument of the logical financial instrument may have restrictions (e.g., restricted to certain merchants, exclude certain merchants, transaction amount restrictions, geographical restrictions, etc.).

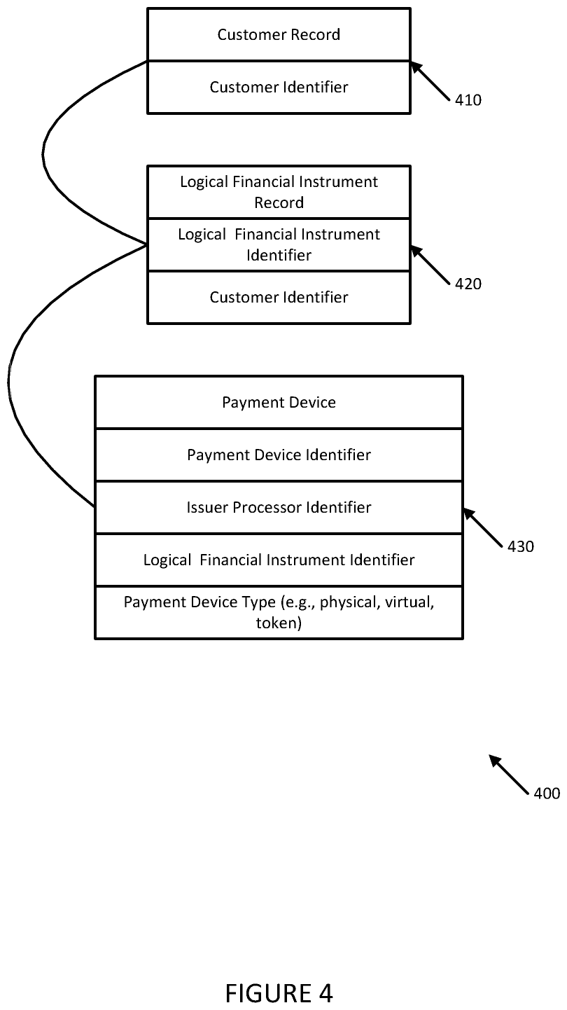

An example card model is provided in FIG. 4. Card model 400 may include customer record 410 that may maintain a customer identifier for the customer.

The customer identifier may be associated with logical financial instrument record 420, which may also include a logical financial instrument identifier. The logical financial instrument identifier may be provided to one or more payment devices 430, which may include the logical financial instrument identifier, a payment device identifier, an optional issuer processor identifier, and a payment device type (e.g., physical, virtual, token, etc.). Thus, multiple payment devices 430 may be associated with the same logical financial instrument identifier and may also have their own payment device identifiers.

Referring again to FIG. 3, in step 310, the customer may create one or more accounts at the financial institution. The accounts may be demand deposit accounts (DDAs), savings accounts, lines of credit, etc. The customer may create and/or close accounts as is necessary and/or desired.

In one embodiment, the customer may create or close the accounts using, for example, a computer program executed on the customer's electronic device (e.g., a financial institution application, browsing to the financial institution's website, etc.).

In step 315, the customer may set one or more preferences for pointing transactions conducted with one of the payment devices associated with the logical financial instrument identifier to one or more of the bank accounts. For example, the customer may specify that all transactions for utilities are pointed at account 1, that all transactions at restaurants are pointed to account 2, etc.

In one embodiment, the customer may set the accounts using, for example, a wizard that may identify broad groupings of transactions for different accounts.

In one embodiment, the customer may select an objective, such as maximizing reward point earning. In another embodiment, the customer may specify a range of transactions (e.g., under $100; between $100 and $1000; over $1000, etc.) for the transactions, a time of the day, month, or year, a geographical location for the transaction, etc.

In one embodiment, a combination of preferences may be set, and the preferences may identify more than one account for the transaction.

In one embodiment, the customer may select the pointing using, for example, a computer program executed on the customer's electronic device (e.g., a financial institution application, browsing to the financial institution's website, etc.).

In step 320, the customer may conduct a transaction using the logical financial instrument. For example, the customer may present a physical card to a merchant point of sale device, may enter a PAN to an e-commerce checkout process, may provide a token to a merchant point of sale device using an electronic wallet, etc.

In step 325, the financial institution computer program may identify one or more accounts for the transaction by, for example, applying the customer's preferences to the transaction.

In step 330, the financial institution computer program may conduct or settle the transaction with the identified accounts. In one embodiment, the accounts may be identified post-processing.

In one embodiment, if the customer changes account preferences after the transaction is complete, the transaction will remain pointed at the original account.

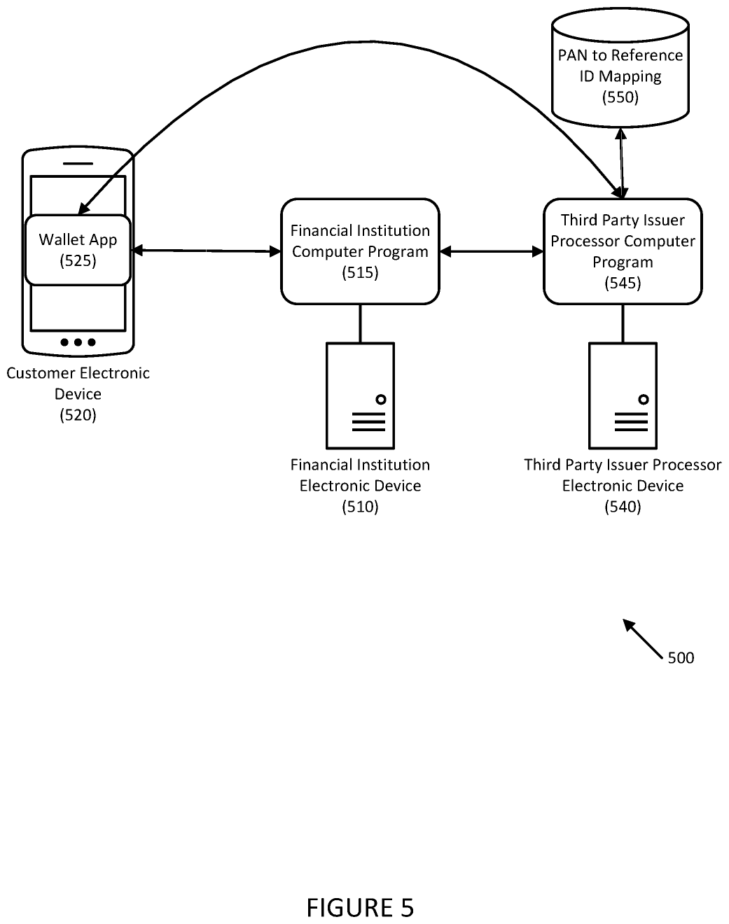

Referring to FIG. 5, a system for payment device issuance, lifecycle management, and use is disclosed according to another embodiment. System 500 may include financial institution electronic device 510 that may execute financial institution computer program 515. Financial institution electronic device 510 may be any suitable electronic device, including servers (e.g., cloud-based and/or physical), workstations, etc. Financial institution computer program 515 may be a computer program that interfaces with an application executed on customer electronic device 520, such as electronic wallet application 525, or “wallet app.” Financial institution computer program 515 may also interface with third party issuer processor computer program 545, which may be executed by third party issuer processor electronic device 540. Third party issuer processor electronic device 540 may be any suitable electronic device, including servers (e.g., cloud-based and/or physical), workstations, etc.

Third party issuer processor computer program 545 may interface with PAN to reference ID mapping database 550, which may maintain a mapping of PANs to unique reference identifiers.

In one embodiment, to be compliant with the Payment Card Industry (PCI) standards, the financial institution computer program 515 may not receive the PAN or other financial instrument information for the customer. Instead, financial institution computer program 515 and third-party issuer processor computer program 545 may use the unique reference identifier to identify the customer, the customer's account, and/or the customer's financial instrument.

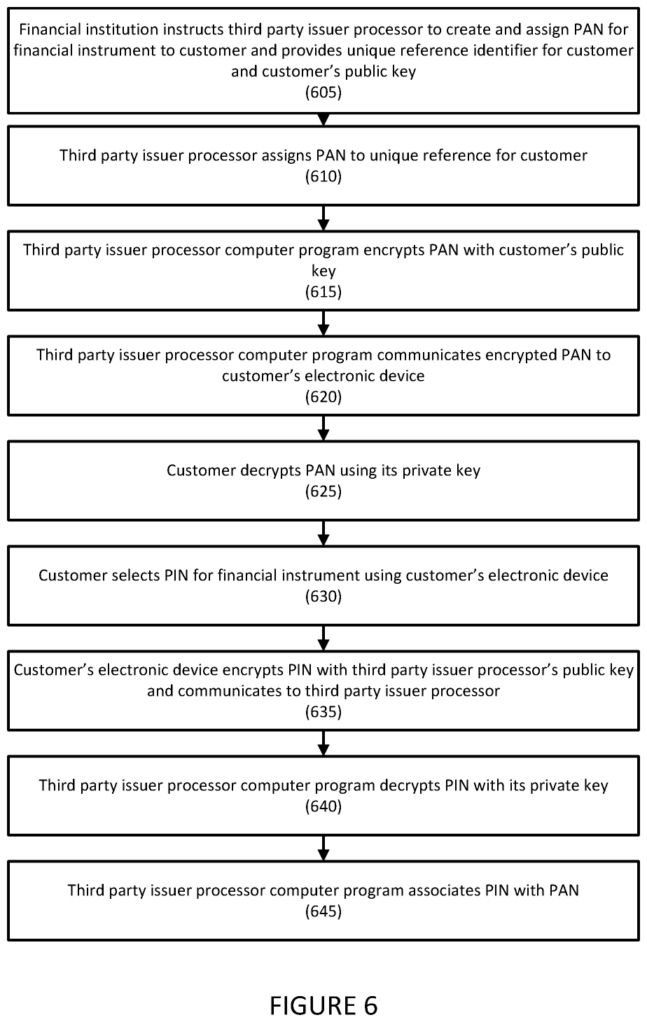

Referring to FIG. 6, a method for payment device issuance, lifecycle management, and use is disclosed according to another embodiment.

In step 605, a financial institution computer program for a financial institution may instruct a third party, such as a third-party issuer processor, to create and assign PAN for a financial instrument to a customer. The financial institution may outsource PAN issuance and lifecycle management to the third-party issuer processor. Because the financial institution does not receive PANs, it does not have to be PCI compliant. Instead, the third-party issuer processor computer program and the financial institution computer program communicate regarding the primary account number using the unique reference identifier.

The financial institution computer program may generate a unique reference identifier for the customer and may provide the unique reference identifier to the third-party issuer processor computer program.

The financial institution computer program may also provide the third-party issuer processor computer program with the customer's public key.

In step 610, the third-party issuer processor computer program may map the unique reference identifier to a PAN for the customer's financial instrument. In one embodiment, the third-party issuer processor computer program may repeat the mapping for all financial instruments assigned to the customer.

In one embodiment, if not provided already, the third-party issuer processor computer program may generate the unique reference identifier for the customer.

In step 615, the third-party issuer processor computer program may encrypt the PAN with the customer's public key, and in step 620, may communicate the encrypted PAN to customer's electronic device.

In step 625, the customer may decrypt the PAN using its private key, and may store it in, for example, an electronic wallet on the customer's electronic device.

In step 630, the customer may select a PIN for one or more financial instruments using, for example, the customer's electronic device.

In step 635, the customer's electronic device may encrypt the PIN with the third-party issuer processor's public key, and may communicate the encrypted PIN to the third party issuer processor computer program.

In step 640 the third-party issuer processor computer program may decrypt the PIN with its private key, and in step 645, may associate the PIN with one or more PAN for the customer's financial instruments.

Although several embodiments have been disclosed, these embodiments are not exclusive to each other, and features from one may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for payment device issuance, lifecycle management, and use, comprising:
issuing, by a financial institution computer program for a financial institution, a first financial instrument to a customer, wherein the first financial instrument is a numberless physical financial instrument having a first primary account number, the first primary account number stored in a chip on the first financial instrument, wherein the first financial instrument is restricted to in-person transactions;
issuing, by the financial institution computer program, a second financial instrument to an electronic wallet for the customer as a digital financial instrument, wherein the second financial instrument has a second primary account number that is different from the first primary account number;
receiving, by the financial institution computer program, a notification that the first financial instrument or the second financial instrument has been lost or compromised;
in response to the first financial instrument being lost or compromised, reissuing, by the financial institution computer program, the first financial instrument with a third primary account number, wherein the second primary account number for the second financial instrument is unchanged; and
in response to the second financial instrument being lost or compromised, reissuing, by the financial institution computer program, the second financial instrument with a fourth primary account number, wherein the first primary account number for the first financial instrument is unchanged.

2. The method of claim 1, further comprising:
receiving, by the financial institution computer program, a personal identification number for the first financial instrument or the second financial instrument;
assigning, by the financial institution computer program, the personal identification number to both the first financial instrument and the second financial instrument;
receiving, by the financial institution computer program, a changed personal identification number for one of the first financial instrument and the second financial instrument; and
assigning, by the financial institution computer program, the changed personal identification number to both the first financial instrument and the second financial instrument.

3. The method of claim 1, wherein the first financial instrument and the second financial instrument are associated with a logical financial instrument identifier.

4. A method for payment device issuance, lifecycle management, and use, comprising:
issuing, by a financial institution computer program for a financial institution, a logical financial instrument identifier to a customer, wherein the logical financial instrument identifier is associated with a plurality of payment devices issued to the customer;
receiving, by the financial institution computer program, a request to create a plurality of accounts from a customer mobile electronic device, wherein the plurality of accounts comprise one of a demand deposit account and a savings account;
creating, by the financial institution computer program, the plurality of accounts;
receiving, by the financial institution computer program, customer preferences for pointing transactions conducted with one of the payment devices associated with the logical financial instrument identifier to one or more of the plurality of accounts;
receiving, by the financial institution computer program, a transaction involving one of the payment devices associated with the logical financial instrument identifier;
identifying, by the financial institution computer program, one or more of the plurality of accounts for the transaction based on the customer preferences; and
settling, by the financial institution computer program, the transaction using the identified one or more accounts.

5. The method of claim 4, wherein the plurality of payment devices comprise a physical payment device, a virtual payment device, and/or a payment token.

6. The method of claim 4, wherein the plurality of accounts further comprise a line of credit.

7. The method of claim 4, further comprising:
receiving, by the financial institution computer program, a request to close one of the plurality of accounts from the customer mobile electronic device; and
closing, by the financial institution computer program, the requested account.

8. The method of claim 4, wherein the customer preferences are based on a merchant type.

9. The method of claim 4, wherein the customer preferences are based on a transaction value.

10. The method of claim 4, wherein the customer preferences are based on a transaction geography.

11. The method of claim 4, wherein the customer preferences are based on reward point earning.

12. The method of claim 4, wherein the plurality of accounts for the transaction are identified after the transaction is complete.

13. A method for payment device issuance, lifecycle management, and use, comprising:
receiving, by a third-party issuer processor computer program and from financial institution computer program for a financial institution, a request to generate a primary account number for a customer, a unique reference identifier for the customer, and a public key for the customer, wherein the financial institution outsources issuance of primary account numbers and lifecycle management of the primary account numbers to the third-party issuer processor;
generating, by the third-party issuer processor computer program, the primary account number;
associating, by the third-party issuer processor computer program, the primary account number with the unique reference identifier;
encrypting, by the third-party issuer processor computer program, the primary account number with the public key for the customer; and
sending, by the third-party issuer processor computer program, the encrypted primary account number to an electronic device associated with the customer, wherein the encrypted primary account number is decrypted using a private key for the customer and is stored in an electronic wallet on the electronic device;
wherein the financial institution complies with standards for the Payment Card Industry.

14. The method of claim 13, further comprising:
receiving, by the third-party issuer processor computer program, a selection of a personal identification number from the customer, wherein the personal identification number is encrypted with a public key for the third-party issuer processor;
decrypting, by the third-party issuer processor computer program, the encrypted personal identification entry with a private key for the third-party issuer processor; and
associating, by the third-party issuer processor computer program, the personal identification entry with the primary account number.

15. The method of claim 14, wherein the third-party issuer processor computer program and the financial institution computer program communicate regarding the primary account number using the unique reference identifier.
